(19) United States
(12) Patent Application Publication
(10) Pub. No.: US 2025/0363290 A1
(43) Pub. Date: Nov. 27, 2025

(54) TEXT PROCESSING METHOD AND APPARATUS, READABLE MEDIUM, AND ELECTRONIC DEVICE

(71) Applicant: Beijing Youzhuju Network Technology Co., Ltd., Beijing (CN)

(72) Inventor: Xiaoshu ZHU, Beijing (CN)

(21) Appl. No.: 18/874,937

(22) PCT Filed: Aug. 28, 2023
(86) PCT No.: PCT/CN2023/115326

§ 371 Date: Dec. 13, 2024

(30) Foreign Application Priority Data
Oct. 27, 2022 (CN) 202211328745.1

(51) Int. Cl. G06F 40/166; G06F 3/04842; G06F 40/106

(52) U.S. Cl. CPC G06F 40/166; G06F 3/04842; G06F 40/106

(57) ABSTRACT

Embodiments of the present disclosure relate to a text processing method and apparatus, a readable medium, and an electronic device. The method includes: determining, from a first text, a plurality of target texts to be modified and a modification reason type of each target text; for each target text, in response to the presence of a similar modified text corresponding to a current target text in the plurality of target texts, displaying a similar information prompt tag corresponding to the current target text, where the similar information prompt tag is used to prompt that there is a similar modified text for the current target text, and the similar modified text is a text with the same modification reason type as the current target text; and displaying similar text information in response to receiving a first operation from a user on the displayed similar information prompt tag.

### CROSS-REFERENCE TO RELATED APPLICATION(S)

The present application is a national stage application filed under 35 U.S.C. 371 based on International Patent Application No. PCT/CN2023/115326, filed Aug. 28, 2023, which claims priority to Chinese Patent Application No. 202211328745.1, entitled “TEXT PROCESSING METHOD AND APPARATUS, READABLE MEDIUM, AND ELECTRONIC DEVICE”, and filed on Oct. 27, 2022, the disclosures of which are incorporated herein by reference in their entireties.

### FIELD

The present disclosure relates to the field of computer technologies, and in particular, to a method and apparatus, a readable medium, and an electronic device for text processing.

### BACKGROUND

Currently, with the development of the society, there is an increasing number of pieces of text information.

### SUMMARY

The Summary is to introduce the concepts in a simplified form, which will be further described in the following Detailed Description. The Summary is neither intended to identify the key or necessary features of the claimed technical solutions, nor is it intended to be used to limit the scope of the claimed technical solutions.

According to a first aspect of embodiments of the present disclosure, there is provided a method for text processing. The method includes:

determining, from a first text, a plurality of target texts to be modified and a modification reason type of each target text;

for each target text, in response to the presence of a similar modified text corresponding to a current target text in the plurality of target texts, displaying a similar information prompt tag corresponding to the current target text, where the similar information prompt tag is used to prompt that the presence of a similar modified text for the current target text, and the similar modified text is a text with the same modification reason type as the current target text; and

displaying similar text information in response to receiving a first operation from a user on the displayed similar information prompt tag, where the similar text information includes the similar modified text.

According to a second aspect of embodiments of the present disclosure, there is provided an apparatus for text processing. The apparatus includes:

a determination module, configured to determine, from a first text, a plurality of target texts to be modified and a modification reason type of each target text;

a first display module, configured to, for each target text, in response to the presence of a similar modified text corresponding to a current target text in the plurality of target texts, display a similar information prompt tag corresponding to the current target text, where the similar information prompt tag is used to prompt that the presence of a similar modified text for the current target text, and the similar modified text is a text with the same modification reason type as the current target text; and

a second display module, configured to display similar text information in response to receiving a first operation from a user on the displayed similar information prompt tag, where the similar text information includes the similar modified text.

According to a third aspect of embodiments of the present disclosure, there is provided a computer-readable medium having a computer program stored thereon, where when the computer program is executed by a processing apparatus, the steps of the method according to the first aspect of the present disclosure are implemented.

According to a fourth aspect of embodiments of the present disclosure, there is provided an electronic device, including:

a storage apparatus having a computer program stored thereon; and

a processing apparatus configured to execute the computer program in the storage apparatus, to perform the steps of the method according to the first aspect of the present disclosure.

With the above technical solution, a plurality of target texts to be modified and a modification reason type of each target text are determined from a first text; for each target text, in response to the presence of a similar modified text corresponding to a current target text in the plurality of target texts, a similar information prompt tag corresponding to the current target text is displayed, where the similar information prompt tag is used to prompt that the presence of a similar modified text for the current target text, and the similar modified text is a text with the same modification reason type as the current target text; and similar text information is displayed in response to receiving a first operation from a user on the displayed similar information prompt tag, where the similar text information includes the similar modified text.

It should be understood that the foregoing general descriptions and the following detailed descriptions are merely exemplary and explanatory; and cannot limit the present disclosure.

### BRIEF DESCRIPTION OF THE DRAWINGS

The above and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale. In the accompanying drawings:

FIG. 1 is a flowchart of a text processing method according to an exemplary embodiment.

FIG. 2 is a schematic diagram of a similar information prompt tag according to an exemplary embodiment.

FIG. 3 is a schematic diagram of a target display page for displaying a similar information prompt tag according to an exemplary embodiment.

FIG. 4 is a schematic diagram of displaying similar text information according to an exemplary embodiment.

FIG. 5 is a flowchart of another text processing method according to an exemplary embodiment.

FIG. 6 is a block diagram of a text processing apparatus according to an exemplary embodiment.

FIG. 7 is a block diagram of a text processing apparatus according to an exemplary embodiment.

FIG. 8 is a block diagram of an electronic device according to an exemplary embodiment.

### DETAILED DESCRIPTION OF EMBODIMENTS

Embodiments of the present disclosure will be described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the drawings and embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit an order of functions performed by these apparatuses, modules, or units or interdependence.

It should be noted that modifiers such as “one” and “a plurality of” mentioned in the present disclosure are illustrative and not restrictive, and those skilled in the art should understand that unless the context clearly indicates otherwise, the modifiers should be understood as “one or more”. In the description of the present disclosure, unless otherwise stated, “a plurality of” means two or more than two, and other quantifiers are similar to this; “at least one item” and “one item or a plurality of items” or similar expressions thereof mean any combination of these items, including a single item or any combination of a plurality of items. For example, at least one item A may represent any number of items A; for another example, one item or a plurality of items in A, B, and C may represent: A, B, C, A-B, A-C, B-C, or A-B-C, where A, B, and C may be single or multiple; “and/or” is an association relationship for describing associated objects, and indicates that there may be three relationships. For example, A and/or B may represent the following three cases: A exists independently, A and B exist at the same time, and B exists independently, where A and B may be singular or plural.

In the embodiments of the present disclosure, although operations or steps are described in the accompanying drawings in a specific order, it should not be understood as requiring that these operations or steps be performed in the specific order shown or in a serial order, or that all illustrated operations or steps be performed to obtain the desired results. In the embodiments of the present disclosure, these operations or steps may be performed sequentially; may also be performed in parallel; or may also be performed partially.

Names of messages or information exchanged between a plurality of apparatuses in the implementation of the present disclosure are used for illustrative purposes only, and are not used to limit the scope of these messages or information.

It may be understood that before the technical solutions disclosed in the embodiments of the present disclosure are used, the user should be informed of the type, scope of use, and usage scenarios of the personal information involved in the present disclosure in an appropriate manner in accordance with relevant laws and regulations, and the user's authorization should be obtained.

For example, when a user's active request is received, a prompt message is sent to the user to specifically prompt the user that the operation requested by the user will need to obtain and use the user's personal information. Therefore, the user can choose whether to provide personal information to the software or hardware, such as an electronic device, an application program, a server, or a storage medium, that executes the operation of the technical solution of the present disclosure.

As an optional but non-limiting implementation, for example, the prompt message may be sent to the user in a pop-up window in response to receiving the user's active request. The prompt message may be presented in text in the pop-up window. In addition, the pop-up window may also contain a select control for the user to select “agree” or “disagree” to provide the personal information to the electronic device.

It may be understood that the above process of notifying and obtaining the user's authorization is only illustrative and does not limit the implementation of the present disclosure. Other methods that comply with relevant laws and regulations may also be applied to the implementation of the present disclosure.

In addition, it may be understood that the data involved in the technical solution (including but not limited to the data itself, the acquisition or use of the data) should comply with the requirements of corresponding laws and regulations and related regulations.

A large amount of text may contain incorrect or inappropriate expressions. Therefore, it is necessary to perform processing such as error correction or polishing on the text. With the development of computer technologies, text error correction or text polishing has been changed from traditional manual processing to a combination of computer automatic processing and manual verification.

The present disclosure is described below with reference to specific embodiments.

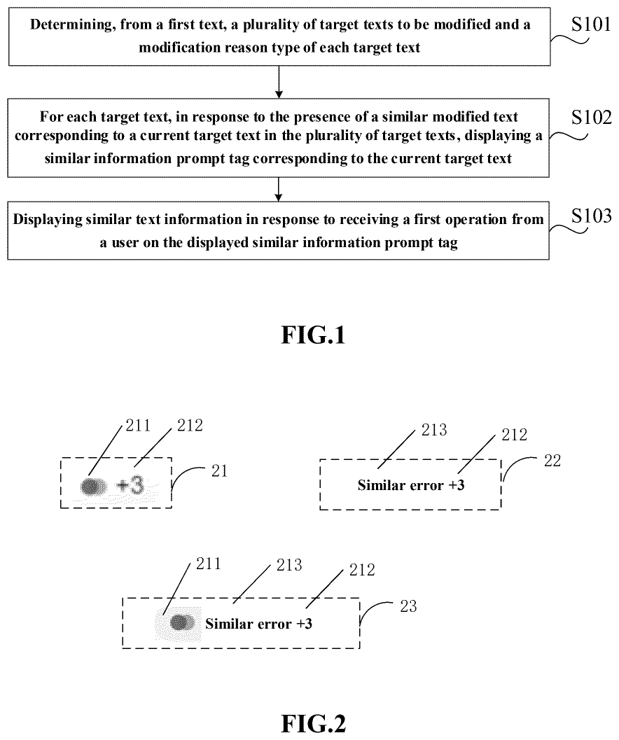

FIG. 1 is a flowchart of a text processing method according to an exemplary embodiment. The method may be applied to an electronic device. The electronic device may include a terminal device, for example, a smart phone, a smart wearable device, a smart speaker, a smart tablet, a personal digital assistant (PDA), a customer premise equipment (CPE), a personal computer, or a vehicle-mounted terminal. The electronic device may also include a server, for example, a local server or a cloud server. As shown in FIG. 1, the method may include the following steps.

Step 101: Determine, from a first text, a plurality of target texts to be modified and a modification reason type of each target text.

The first text may be a text to be processed (for example, the text to be processed that is inputted by a user or the text to be processed that is obtained from a database or a server), and the target text may be a subset of the first text. For example, the first text may be an article, and the target text may be a word, a sentence, or a paragraph in the article. For another example, the first text may be a paragraph (one or more paragraphs of text), and the target text may be a word or a sentence in the paragraph. For another example, the first text may be a sentence, and the target text may be a word in the sentence. The first text may also be any language, for example, any one or more of Chinese, English, German, Japanese, and the like.

The processing of the first text may include any one or more of processing manners such as error correction, polishing, and rewriting.

Taking the first text as an English article inputted by a user and the first text being processed by error correction as an example, in this step, objective error correction processing may be performed on the English article (first text), for example, whether there is an error in the first text is checked, and texts (for example, a word or a sentence) with errors are used as a plurality of target texts to be modified. The errors in the first text may be divided into a plurality of modification reason types (which may also be referred to as error types), and the modification reason types may include types such as a spelling error, a grammar error, and a format error.

In some embodiments, the modification reason type may include a plurality of levels of reasons. For example, the modification reason type may be divided into N levels (N may be any preset positive integer greater than 1, for example, 2, 3, 5, or 10). Taking N as 2 as an example, the modification reason type may include a first modification reason type and a second modification reason type, where the second modification reason type may be subordinate to the first modification reason type. For example, the first modification reason type may include types such as a spelling error, a grammar error, and a format error. A grammar error in the first modification reason type may include the following second modification reason types: incorrect part of speech, a missing article, a missing pronoun, and the like.

In some embodiments, each target text to be modified may correspond to one modification reason type or a plurality of modification reason types. Each modification reason type may correspond to the same or different modification manner.

In some implementations, the target text to be modified may be obtained by performing error correction processing on the first text, so that the target text may correspond to one modification reason type, and the modification reason type may correspond to one modification manner. For example, the modification manner corresponding to the missing modification reason type may be adding, and the modification manner corresponding to the redundant modification reason type may be deleting. The modification manner corresponding to the wrong modification reason type may be replacing.

In some other implementations, the target text to be modified may be obtained by performing polishing processing on the first text, so that the target text may correspond to a plurality of modification reason types, and each modification reason type may also correspond to a plurality of modification manners. For example, a target text to be polished may be modified in the replacing and/or deleting manner.

Step 102: For each target text, in response to the presence of a similar modified text corresponding to a current target text in the plurality of target texts, display a similar information prompt tag corresponding to the current target text.

The similar information prompt tag is used to prompt that there is a similar modified text for the current target text, and the similar modified text is a text with the same modification reason type as the current target text.

In some embodiments, target texts with the same modification reason type may be used as similar modified texts for each other.

In some other embodiments, target texts with the same modification reason type and the same modification manner may be used as similar modified texts for each other.

In some other embodiments, one or more first preset reason types may be preconfigured. If the modification reason type is the first preset reason type, the target texts corresponding to the modification reason type may be used as similar modified texts for each other. In contrast, if the modification reason type is not the preconfigured first preset reason type, for example, the modification reason type may be a second preset reason type (the second preset reason type is different from the first preset reason type), the target texts corresponding to the modification reason type may not be used as similar modified texts for each other. That is, there may be no similar modified text for the target text corresponding to the modification reason type.

For example, the modification reason type includes “missing pronoun” and “missing article” in a grammar error, where “missing article” is one of the preconfigured first preset reason types, and “missing pronoun” is not the preconfigured first preset reason type (for example, it may be the second preset reason type). There are six target texts to be modified in the first text. The modification reason type of four first target texts is “missing article”, and the modification reason type of two second target texts is “missing pronoun”. The four first target texts with the modification reason type of “missing article” may be used as similar modified texts for each other. That is, each first target text has a similar modified text, and a target number of corresponding similar modified texts is 4 (in a counting manner including the first target text) or 3 (in a counting manner excluding the first target text). However, the second target text has no similar modified text.

In some embodiments, a preset symbol may be displayed before the target number, and the preset symbol may be a plus sign (+), a multiplication sign (*), or another symbol.

In some implementations, different preset symbols may represent different meanings. For example, in the case that the target number is in the counting manner including the first target text, the preset symbol may be a multiplication sign (*), and the first target text in the foregoing example may be displayed as “*4”. For another example, in the case that the target number is in the counting manner excluding the first target text, the preset symbol may be a plus sign (+), and the first target text in the foregoing example may be displayed as “+3”.

The similar information prompt tag includes one or more of a first preset prompt icon, a first preset prompt text, and the target number, where the target number is used to represent the number of similar modified texts.

FIG. 2 is a schematic diagram of a similar information prompt tag according to an exemplary embodiment. As shown in FIG. 2, the similar information prompt tag may be displayed in a form shown by a first tag 21, a second tag 22, or a third tag 23 in FIG. 2. As shown by the first tag 21, the similar information prompt tag may include a first preset prompt icon 211 and a target number 212. As shown by the second tag 22, the similar information prompt tag may include a first preset prompt text 213 and the target number 212. As shown by the third tag 23, the similar information prompt tag may include the first preset prompt icon 211, the first preset prompt text 213, and the target number 212. The first preset prompt text may be “similar error”, and the target number may be “+3”.

In some embodiments, a modification prompt tag and the similar information prompt tag corresponding to the current target text may be displayed in a first area on a target display page. The first area may be any area on the target display page.

In some implementations, the target display page may include a first display page displaying the first text.

In some other implementations, the target display page may also be a second display page generated on the first display page displaying the first text. For example, the second display page is generated in a pop-up window form.

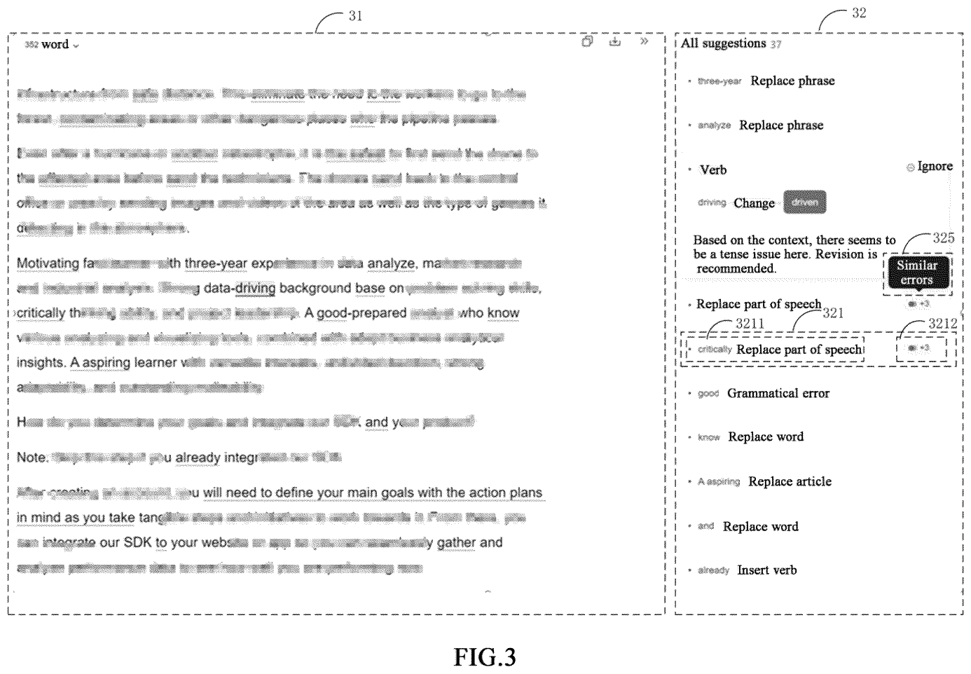

FIG. 3 is a schematic diagram of a target display page for displaying a similar information prompt tag according to an exemplary embodiment. As shown in FIG. 3, the target display page may include a text display area 31 and a modification suggestion display area 32, where the text display area 31 may be used to display the foregoing first text, and the modification suggestion display area 32 may be used to display related information, for example, a given modification suggestion, of the plurality of target texts to be modified.

The modification suggestion display area 32 may include a plurality of first areas 321, and each first area 321 may display a modification prompt tag 3211 and a similar information prompt tag 3212 corresponding to the current target text.

It should be noted that the similar information prompt tag 3212 may be displayed in the form shown by the first tag 21, the second tag 22, or the third tag 23 in FIG. 2.

In some implementations, in response to receiving a focus moving operation inputted by a user, in a case that a focus moves to the first area, second preset prompt information 325 may also be displayed. The second preset prompt information may be used to prompt information displayed by the similar information prompt tag. For example, the second preset prompt information may include the text “similar error”.

The focus moving operation may be a moving operation inputted by the user on an input device, and the input device may include a mouse, a keyboard, a stylus, a touchscreen, or the like. For example, when the user moves a cursor of the mouse to the first area, the second preset prompt information may be displayed.

In some other implementations, the second preset prompt information 325 may also be displayed in response to receiving a focus moving operation entered by the user and when the focus moves to an area displayed by the similar information prompt tag.

In this way; the user can be prompted of the information displayed by the similar information prompt tag.

In step 103, similar text information is displayed in response to receiving a first operation from a user on the displayed similar information prompt tag.

The similar text information may include the similar modified text. For example, the similar text information may display the similar modified text in a list form.

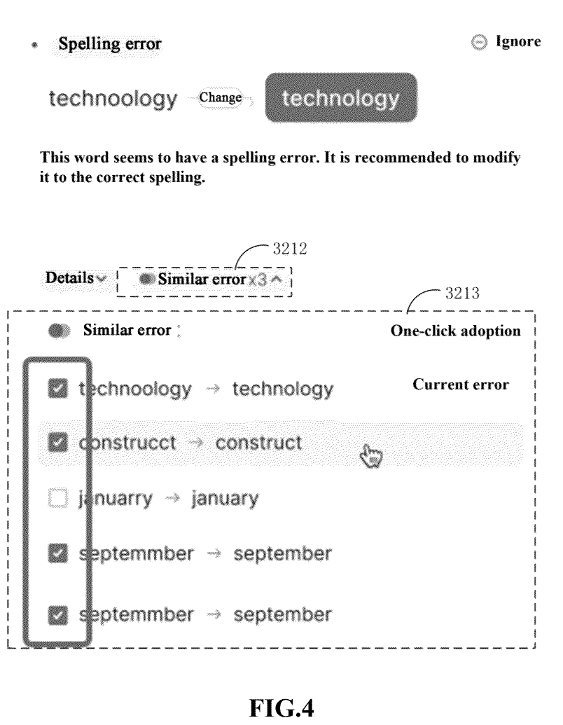

FIG. 4 is a schematic diagram of displaying similar text information according to an exemplary embodiment. As shown in FIG. 4, the similar text information may display one or more similar modified texts in a list form. For example, FIG. 4 includes a similar information prompt tag 3212 and similar text information 3213, and the similar text information 3213 may include one or more similar modified texts (for example, similar errors such as technoology, construcct, januarry; and septemmber in the figure).

With the above method, a plurality of target texts to be modified and a modification reason type of each target text are determined from a first text; for each target text, in response to the presence of a similar modified text corresponding to a current target text in the plurality of target texts, a similar information prompt tag corresponding to the current target text is displayed, and the similar information prompt tag is used to prompt that the presence of a similar modified text for the current target text, and the similar modified text is a text with the same modification reason type as the current target text; and similar text information is displayed in response to receiving a first operation from a user on the displayed similar information prompt tag, and the similar text information includes the similar modified text. In this way, the similar modified text may be prompted to the user through the similar information prompt tag of the current target text, so that similar modifications in the first text can be summarized more efficiently. The user may conveniently view and check the similar modified texts uniformly, so that the user has a clearer perception of a similar modification suggestion or error, thereby improving the text processing efficiency and user experience.

In some examples of the present disclosure, after the similar text information is displayed in step S103, the method may further include: in response to receiving a second operation from a user on a target similar text in the displayed similar modified texts, prompting location information of the target similar text according to a preset prompt strategy.

The target similar text may be any text in the similar modified texts.

The preset prompt strategy includes one or more of the following:

Strategy 1: Indicating a location of the target similar text in the first text by a first preset format.

In some embodiments, the second operation may include a single-click operation (for example, a single-click operation performed using a mouse or a stylus). When the user single-clicks a target similar text, the target similar text in the first text may be set to the first preset format, and the first preset format may include one or more of formats such as bolding, underlining, italicizing, marking the text in red, and marking the background in red.

For example, when the user single-clicks one of the similar modified texts, the similar modified text that is single-clicked may be used as the target similar text, and the location of the target similar text in the first text in the text display area is displayed with a red background.

Strategy 2: Switching an input focus of the target display page to a second area that displays a modification prompt tag corresponding to the target similar text.

In some embodiments, the second operation may include a double-click operation (for example, a

double-click operation performed using a mouse or a stylus).

For example, when the user double-clicks one of the similar modified texts, the similar modified text that is double-clicked may be used as the target similar text, and the input focus of the target display page is switched to the second area that displays the modification prompt tag corresponding to the target similar text. For example, the modification prompt tag and the similar information prompt tag corresponding to the current target text may be displayed in a modification suggestion card, and the second area may be an area where the modification suggestion card is located.

Furthermore, when the user double-clicks the target similar text, the input focus of the target display page may be switched to the second area that displays the modification prompt tag corresponding to the target similar text, and the location of the target similar text in the first text is indicated in the first preset format. For example, the display location of the target similar text in the first text is displayed with a red background.

In this way; the user may conveniently view the target similar text, and the review efficiency of the user on the modification suggestion may be improved.

In some embodiments of the present disclosure, a modification suggestion for the similar modified text may also be accepted with one click. For example, text to be modified may be determined from the similar modified texts, and the text to be modified is modified according to a preset modification strategy in response to receiving a modification confirmation operation inputted by the user.

In some embodiments, the modification confirmation operation may be that the user clicks a preset modification tag. For example, when the user clicks the preset modification tag, the text to be modified is determined from the similar modified texts, and the text to be modified is modified according to the preset modification strategy. The preset modification tag may be displayed as “Accept all”.

In some implementations, the preset modification tag may be displayed when the similar information prompt tag is displayed. For example, the preset modification tag may be displayed adjacent to the similar information prompt tag.

In some other implementations, the preset modification tag may be displayed when the similar text information is displayed. For example, the similar information prompt tag may be first displayed. When the user clicks the similar information prompt tag, the similar information prompt tag and the similar text information are displayed at the same time, and the preset modification tag is displayed adjacent to the similar information prompt tag.

In this way; the user may accept the modification suggestion for the similar modified text with one click by using the preset modification tag, so that the similar modified text may be efficiently modified, thereby improving the efficiency of the user in modifying the text.

Determining, from the similar modified texts, the text to be modified may include one or more of the following manners:

Manner 1: Determining a similar modified text that is selected by default as the text to be modified.

The default selection manner may include one or more of the following manners:

In some embodiments, all the similar modified texts may be used as the similar modified texts that are selected by default.

In some other embodiments, similar modified texts in a same chapter, a same paragraph, or a same page as the current target text may be used as the similar modified texts that are selected by default.

In some other embodiments, the top M similar modified texts with a smallest ranking of a to-be-determined distance from the current target text may be used as the similar modified texts that are selected by default, and the to-be-determined distance may be a number of words, a number of characters, or a number of words between the similar modified text and the current target text, and M may be any preset positive integer, for example, 3, 5, or 10.

Manner 2: Determining a similar modified text selected by the user as the text to be modified.

In some embodiments, the text to be modified selected by the user may be determined based on a click operation performed by the user on the similar modified text. The click operation may be an operation that the user performs on the similar modified text by using an input device. The input device may include a mouse, a keyboard, a stylus, a touchscreen, or the like. The click operation may include one or more of a single-click operation, a double-click operation, and a K-click operation, and K may be any positive integer greater than or equal to 3, for example, a triple-click operation.

In some implementations, the user may select a plurality of similar modified texts as the texts to be modified by using a plurality of click operations.

In some implementations, the user may also select or deselect the same similar modified text by using a plurality of click operations. For example, when the user clicks the similar modified text for the first time, the user may select the similar modified text. When the user clicks the similar modified text again, the user may deselect the similar modified text. When the user clicks the similar modified text again, the user may select the similar modified text again.

In some embodiments, the similar text information may further include a select control corresponding to each similar modified text, and the select control is used to represent whether the similar modified text is selected. In this way, a similar modified text corresponding to a selected select control may be used as the text to be modified in response to receiving a selection operation from the user on the select control.

With the above manner, the user can select a specific range for accepting with one click, thereby completing a more efficient modification operation.

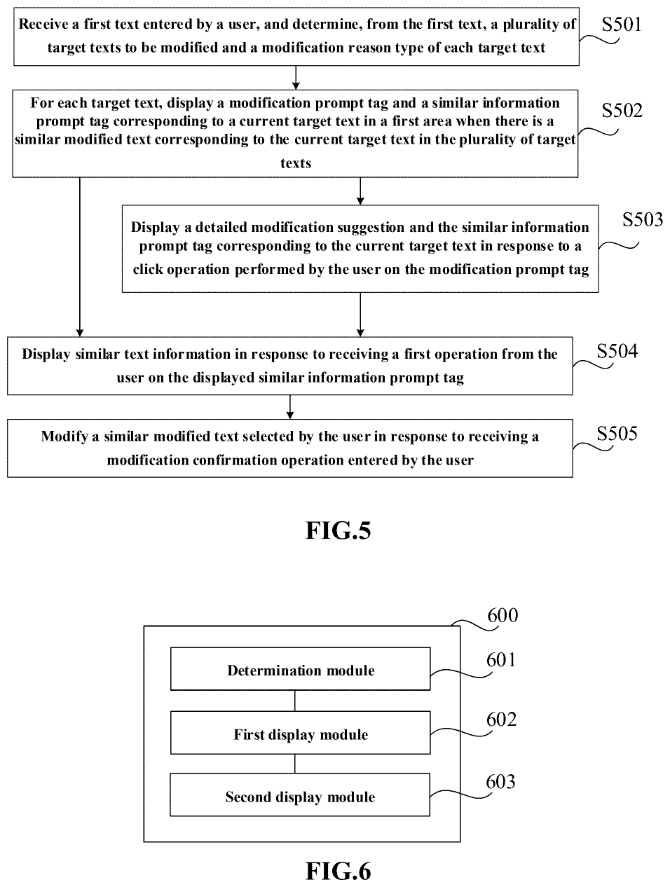

FIG. 5 is a flowchart of another method for text processing according to an exemplary embodiment. As shown in FIG. 5, the method may include the following steps.

Step 501: Receive a first text inputted by a user, and determine, from the first text, a plurality of target texts to be modified and a modification reason type of each target text.

Step 502: For each target text, display a modification prompt tag and a similar information prompt tag corresponding to a current target text in a first area in response to the presence of a similar modified text corresponding to the current target text in the plurality of target texts.

Step 503: Display a detailed modification suggestion and the similar information prompt tag corresponding to the current target text in response to a click operation performed by the user on the modification prompt tag.

Step 504: Display similar text information in response to receiving a first operation from the user on the displayed similar information prompt tag.

The similar text information may include one or more similar modified texts and a select control corresponding to each similar modified text.

A select control corresponding to each similar modified text may also be included in the similar text information, so that the similar modified text may be selected and modified.

In some embodiments, the similar information prompt tag and the similar text information are displayed at the same time when the user clicks the similar information prompt tag, and the preset modification tag is displayed adjacent to the similar information prompt tag.

Step 505: Modify a similar modified text selected by the user in response to receiving a modification confirmation operation inputted by the user.

For example, the modification confirmation operation may be that the user clicks a preset modification tag. For example, when the user clicks the preset modification tag, the text to be modified is determined from the similar modified texts, and the text to be modified is modified according to the preset modification strategy. The preset modification tag may be displayed as “Accept all”.

With the above manner, the similar modified text can be prompted to the user through the similar information prompt tag of the current target text, and the modification suggestion for the similar modified text selected by the user can be accepted with one click (for example, the similar modified text selected by the user can be modified with one click) by using the modification confirmation operation inputted by the user. In this way; the user can conveniently view and check the similar modified texts uniformly, and modify the similar modified texts, thereby improving the text processing efficiency and user experience.

FIG. 6 is a block diagram of a text processing apparatus 600) according to an exemplary embodiment. As shown in FIG. 6, the apparatus 600 may include:

a determination module 601, configured to determine, from a first text, a plurality of target texts to be modified and a modification reason type of each target text;

a first display module 602, configured to, for each target text, in response to the presence of a similar modified text corresponding to a current target text in the plurality of target texts, display a similar information prompt tag corresponding to the current target text, where the similar information prompt tag is used to prompt that the presence of a similar modified text for the current target text, and the similar modified text is a text with the same modification reason type as the current target text; and

a second display module 603, configured to display similar text information in response to receiving a first operation from a user on the displayed similar information prompt tag, where the similar text information includes the similar modified text.

According to one or more embodiments of the present disclosure, the similar information prompt tag includes one or more of a first preset prompt icon, a first preset prompt text, and a target number, where the target number is used to represent the number of similar modified texts.

According to one or more embodiments of the present disclosure, the first display module 602 is configured to display a modification prompt tag and the similar information prompt tag corresponding to the current target text in a first area on a target display page, where the target display page includes a first display page displaying the first text, and the modification prompt tag is used to indicate a modification reason and/or a modification manner of the current target text.

According to one or more embodiments of the present disclosure, in response to receiving a focus moving operation inputted by a user, in a case that a focus moves to the first area, the first display module 602 is further configured to display second preset prompt information, where the second preset prompt information is used to prompt information displayed by the similar information prompt tag.

According to one or more embodiments of the present disclosure, the second display module 603 is further configured to prompt location information of a target similar text according to a preset prompt strategy in response to receiving a second operation from a user on the target similar text in the displayed similar modified texts.

According to one or more embodiments of the present disclosure, the preset prompt strategy includes one or more of the following:

indicating a location of the target similar text in the first text by a first preset format; and

switching an input focus of the target display page to a second area that displays a modification prompt tag corresponding to the target similar text.

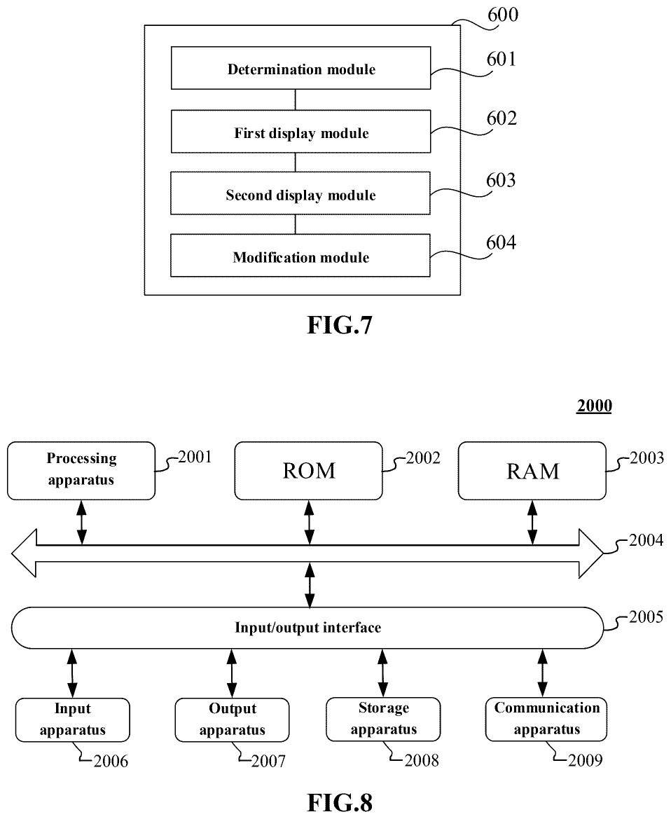

FIG. 7 is a block diagram of an apparatus 600 for text processing according to an exemplary embodiment. As shown in FIG. 7, the apparatus 600 may further include:

a modification module 604, configured to determine text to be modified from the similar modified texts, and modify the text to be modified according to a preset modification strategy in response to receiving a modification confirmation operation inputted by the user.

According to one or more embodiments of the present disclosure, the modification module 604 is configured to determine a similar modified text selected by the user as the text to be modified, or determine a similar modified text that is selected by default as the text to be modified.

According to one or more embodiments of the present disclosure, the similar text information further includes a select control corresponding to each similar modified text, and the select control is used to represent whether the similar modified text is selected. The modification module 604 is configured to use a similar modified text corresponding to a selected select control as the text to be modified in response to receiving a selection operation from the user on the select control.

For the apparatus in the foregoing embodiments, the specific manner in which each module performs an operation has been described in detail in the embodiments related to the method, and will not be described in detail here.

Reference is made to FIG. 7 below, which is a schematic diagram of a structure of an electronic device 2000 (for example, a terminal device or a server) suitable for implementing the embodiments of the present disclosure. The terminal device in the embodiments of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The 30) server in the embodiments of the present disclosure may include, but is not limited to, a local server, a cloud server, a single server, a distributed server, etc. The electronic device shown in FIG. 7 is merely an example, and shall not impose any limitation on the function and scope of use of the embodiments of the present disclosure.

As shown in FIG. 7, the electronic device 2000 may include a processing apparatus (such as a central processor, a graphics processor, etc.) 2001, which may perform a variety of appropriate actions and processing in accordance with a program stored in a read-only memory (ROM) 2002 or a program loaded from a storage 35 apparatus 2008 into a random access memory (RAM) 2003. The RAM 2003 further stores various programs and data required for the operation of the electronic device 2000. The processing apparatus 2001, the ROM 2002, and the RAM 2003 are connected to each other through a bus 2004. An input/output (I/O) interface 2005 is also connected to the bus 2004.

Generally, the following apparatuses may be connected to the input/output interface 2005: an input apparatus 2006 including, for example, a touch screen, a touchpad, a keyboard, a mouse, a camera, a microphone, an accelerometer, and a gyroscope; an output apparatus 2007 including, for example, a liquid crystal display (LCD), a speaker, and a vibrator; the storage apparatus 2008 including, for example, a tape and a hard disk; and a communication apparatus 2009. The communication apparatus 2009 may allow the electronic device 2000 to perform wireless or wired communication with other devices to exchange data. Although FIG. 7 shows the electronic device 2000 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, the embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 2009 and installed, or installed from the storage apparatus 2008, or installed from the ROM 2002. When the computer program is executed by the processing apparatus 2001, the above functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may include, but is not limited to, electric, magnetic, optical, electromagnetic. infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, where the data signal carries computer-readable program code. The propagated data signal may be in various forms, including but not limited to an electromagnetic signal, an optical signal, or any suitable combination thereof. The computer-readable signal medium may also be any computer-readable medium other than the computer-readable storage medium.

The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server can communicate using any currently known or future-developed network protocol such as a hypertext transfer protocol (HTTP), and can be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The foregoing computer-readable medium may be contained in the foregoing electronic device. Alternatively, the computer-readable medium may exist independently, without being assembled into the electronic device.

The computer-readable medium carries one or more programs that, when executed by the electronic device, cause the electronic device to: determine, from a first text, a plurality of target texts to be modified and a modification reason type of each target text;

for each target text, in response to the presence of a similar modified text corresponding to a current target text in the plurality of target texts, display a similar information prompt tag corresponding to the current target text, where the similar information prompt tag is used to prompt that the presence of a similar modified text for the current target text, and the similar modified text is a text with the same modification reason type as the current target text; and

display similar text information in response to receiving a first operation from a user on the displayed similar information prompt tag, where the similar text information includes the similar modified text.

The computer program code for performing the operations in the present disclosure may be written in one or more programming languages or a combination thereof, where the programming languages include but are not limited to object-oriented programming languages such as Java, Smalltalk, and C++, and further include conventional procedural programming languages such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case involving the remote computer, the remote computer may be connected to the computer of the user through any type of network, including a local area network (LAN) or a wide area network (WAN), or may be connected to an external computer (for example, connected through the Internet using an Internet service provider).

The flowcharts and block diagrams in the accompanying drawings illustrate the possibly implemented architecture, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, functions marked in the blocks may also occur in an order different from that marked in the accompanying drawings. For example, two blocks shown in succession may actually be performed substantially in parallel, or they may sometimes be performed in the reverse order. depending on a function involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The modules involved in the embodiments described in the present disclosure may be implemented by software, or may be implemented by hardware. The name of a module does not constitute a limitation on the module itself in some cases. For example, the determination module may alternatively be described as “a module for determining, from a first text, a plurality of target texts to be modified and a modification reason type of each target text”.

The functions described hereinabove in this document may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

According to one or more embodiments of the present disclosure, a method for text processing is provided. The method includes:

determining, from a first text, a plurality of target texts to be modified and a modification reason type of each target text;

for each target text, in response to the presence of a similar modified text corresponding to a current target text in the plurality of target texts, displaying a similar information prompt tag corresponding to the current target text, where the similar information prompt tag is used to prompt that the presence of a similar modified text for the current target text, and the similar modified text is a text with the same modification reason type as the current target text; and

displaying similar text information in response to receiving a first operation from a user on the displayed similar information prompt tag, where the similar text information includes the similar modified text.

According to one or more embodiments of the present disclosure, the similar information prompt tag includes one or more of a first preset prompt icon, a first preset prompt text, and a target number, where the target number is used to represent the number of similar modified texts.

According to one or more embodiments of the present disclosure, displaying a similar information prompt tag corresponding to a current target text includes:

displaying a modification prompt tag and the similar information prompt tag corresponding to the current target text in a first area on a target display page, where the target display page includes a first display page displaying the first text, and the modification prompt tag is used to indicate a modification reason and/or a modification manner of the current target text.

According to one or more embodiments of the present disclosure, the method further includes:

in response to receiving a focus moving operation inputted by a user, in a case that a focus moves to the first area, displaying second preset prompt information, wherein the second preset prompt information is used to prompt information displayed by the similar information prompt tag.

According to one or more embodiments of the present disclosure, the method further includes:

prompting location information of a target similar text according to a preset prompt strategy in response to receiving a second operation from a user on the target similar text in the displayed similar modified texts.

According to one or more embodiments of the present disclosure, the preset prompt strategy includes one or more of the following:

indicating a location of the target similar text in the first text by a first preset format; and

switching an input focus of the target display page to a second area that displays a modification prompt tag corresponding to the target similar text.

According to one or more embodiments of the present disclosure, the method further includes:

determining text to be modified from the similar modified texts; and

modifying the text to be modified according to a preset modification strategy in response to receiving a modification confirmation operation inputted by the user.

According to one or more embodiments of the present disclosure, determining text to be modified from the similar modified texts includes:

using a similar modified text selected by the user as the text to be modified; or using a similar modified text that is selected by default as the text to be modified.

According to one or more embodiments of the present disclosure, the similar text information further includes a select control corresponding to each similar modified text, and the select control is used to represent whether the similar modified text is selected. Using a similar modified text selected by the user as the text to be modified includes:

using a similar modified text corresponding to a selected select control, as the text to be modified in response to receiving a selection operation from the user on the select control.

According to one or more embodiments of the present disclosure, an apparatus for text processing is provided. The apparatus includes:

a determination module, configured to determine, from a first text, a plurality of target texts to be modified and a modification reason type of each target text;

a first display module, configured to, for each target text, in response to the presence of a similar modified text corresponding to a current target text in the plurality of target texts, display a similar information prompt tag corresponding to the current target text, where the similar information prompt tag is used to prompt that the presence of a similar modified text for the current target text, and the similar modified text is a text with the same modification reason type as the current target text; and

a second display module, configured to display similar text information in response to receiving a first operation from a user on the displayed similar information prompt tag, where the similar text information includes the similar modified text.

According to one or more embodiments of the present disclosure, the similar information prompt tag includes one or more of a first preset prompt icon, a first preset prompt text, and a target number, where the target number is used to represent the number of similar modified texts.

According to one or more embodiments of the present disclosure, the first display module is configured to display a modification prompt tag and the similar information prompt tag corresponding to the current target text in a first area on a target display page, where the target display page includes a first display page displaying the first text, and the modification prompt tag is used to indicate a modification reason and/or a modification manner of the current target text.

According to one or more embodiments of the present disclosure, the first display module is further configured to in response to receiving a focus moving operation inputted by a user, in a case that a focus moves to the first area, display second preset prompt information, where the second preset prompt information is used to prompt information displayed by the similar information prompt tag.

According to one or more embodiments of the present disclosure, the second display module is further configured to prompt location information of a target similar text according to a preset prompt strategy in response to receiving a second operation from a user on the target similar text in the displayed similar modified texts.

According to one or more embodiments of the present disclosure, the preset prompt strategy includes one or more of the following:

indicating a location of the target similar text in the first text by a first preset format; and

switching an input focus of the target display page to a second area that displays a modification prompt tag corresponding to the target similar text.

According to one or more embodiments of the present disclosure, the apparatus further includes:

a modification module, configured to determine text to be modified from the similar modified texts, and modify the text to be modified according to a preset modification strategy in response to receiving a modification confirmation operation inputted by the user.

According to one or more embodiments of the present disclosure, the modification module is configured to determine a similar modified text selected by the user as the text to be modified, or determine a similar modified text that is selected by default as the text to be modified.

According to one or more embodiments of the present disclosure, the similar text information further includes a select control corresponding to each similar modified text, and the select control is used to represent whether the similar modified text is selected. The modification module is configured to use a similar modified text corresponding to a selected select control as the text to be modified in response to receiving a selection operation from the user on the select control.

The foregoing descriptions are merely preferred embodiments of the present disclosure and descriptions of the applied technical principles. A person skilled in the art should understand that the scope of disclosure involved in the present disclosure is not limited to the technical solutions formed by a specific combination of the foregoing technical features, and shall also cover other technical solutions formed by any combination of the foregoing technical features or equivalent features thereof without departing from the foregoing concept of disclosure. For example, a technical solution formed by replacing the foregoing features with technical features with similar functions disclosed in the present disclosure (but not limited thereto).

In addition, although the various operations are depicted in a specific order, it should be understood as requiring these operations to be performed in the specific order shown or in a sequential order. Under specific circumstances, multitasking and parallel processing may be advantageous. Similarly, although several specific implementation details are included in the foregoing discussions, these details should not be construed as limiting the scope of the present disclosure. Some features that are described in the context of separate embodiments may alternatively be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims. For the apparatus in the foregoing embodiments, the specific manner in which each module performs an operation has been described in detail in the embodiments related to the method, and will not be described in detail here.

1. A method for text processing, comprising:
determining, from a first text, a plurality of target texts to be modified and a modification reason type of each target text;
for each target text, in response to a presence of a similar modified text corresponding to a current target text in the plurality of target texts, displaying a similar information prompt tag corresponding to the current target text, wherein the similar information prompt tag is used to prompt the presence of the similar modified text for the current target text, and the similar modified text is a text with a same modification reason type as the current target text; and
displaying similar text information in response to receiving a first operation from a user on the displayed similar information prompt tag, wherein the similar text information comprises the similar modified text.

2. The method according to claim 1, wherein the similar information prompt tag comprises one or more of a first preset prompt icon, a first preset prompt text, and a target number, wherein the target number is used to represent a number of similar modified texts.

3. The method according to claim 1, wherein displaying the similar information prompt tag corresponding to the current target text comprises:
displaying a modification prompt tag and the similar information prompt tag corresponding to the current target text in a first area of a target display page, wherein the target display page comprises a first display page displaying the first text, and the modification prompt tag is used to indicate a modification reason and/or a modification manner of the current target text.

4. The method according to claim 3, wherein the method further comprises:
in response to receiving a focus moving operation inputted by the user, in a case that a focus moves to the first area, displaying second preset prompt information, wherein the second preset prompt information is used to prompt information displayed by the similar information prompt tag.

5. The method according to claim 3, wherein the method further comprises:
prompting location information of a target similar text according to a preset prompt strategy in response to receiving a second operation from the user on the target similar text in the displayed similar modified texts.

6. The method according to claim 5, wherein the preset prompt strategy comprises one or more of:
indicating a location of the target similar text in the first text in a first preset format; and
switching an input focus of the target display page to a second area that displays a modification prompt tag corresponding to the target similar text.

7. The method according to claim 1, wherein the method further comprises:
determining a text to be modified from the similar modified texts; and
modifying the text to be modified according to a preset modification strategy in response to receiving a modification confirmation operation inputted by the user.

8. The method according to claim 7, wherein determining the text to be modified from the similar modified texts comprises:
determining a similar modified text selected by the user as the text to be modified; or
determining a similar modified text that is selected by default as the text to be modified.

9. The method according to claim 7, wherein the similar text information further comprises a select control corresponding to each similar modified text, and the select control is configured to represent whether the similar modified text is selected; and determining the similar modified text selected by the user as the text to be modified comprises:
in response to receiving a selection operation from the user on the select control, determining a similar modified text corresponding to the selected select control as the text to be modified.

10. (canceled)

11. A non-transitory computer-readable medium having a computer program stored thereon, wherein when the computer program is executed by processor, causing to the processor to:
determine, from a first text, a plurality of target texts to be modified and a modification reason type of each target text;
for each target text, in response to a presence of a similar modified text corresponding to a current target text in the plurality of target texts, display a similar information prompt tag corresponding to the current target text, wherein the similar information prompt tag is used to prompt the presence of the similar modified text for the current target text, and the similar modified text is a text with a same modification reason type as the current target text; and
display similar text information in response to receiving a first operation from a user on the displayed similar information prompt tag, wherein the similar text information comprises the similar modified text.

12. An electronic device, comprising:
a memory having a computer program stored thereon; and
a processor configured to execute the computer program in the memory to:
determine, from a first text, a plurality of target texts to be modified and a modification reason type of each target text;
for each target text, in response to a presence of a similar modified text corresponding to a current target text in the plurality of target texts, display a similar information prompt tag corresponding to the current target text, wherein the similar information prompt tag is used to prompt the presence of the similar modified text for the current target text, and the similar modified text is a text with a same modification reason type as the current target text; and
display similar text information in response to receiving a first operation from a user on the displayed similar information prompt tag, wherein the similar text information comprises the similar modified text.

13. The device according to claim 12, wherein the similar information prompt tag comprises one or more of a first preset prompt icon, a first preset prompt text, and a target number, wherein the target number is used to represent a number of the similar modified texts.

14. The device according to claim 12, wherein the computer program causing the processor to display the similar information prompt tag corresponding to the current target text comprises instructions to:
display a modification prompt tag and the similar information prompt tag corresponding to the current target text in a first area of a target display page, wherein the target display page comprises a first display page displaying the first text, and the modification prompt tag is used to indicate a modification reason and/or a modification manner of the current target text.

15. The device according to claim 14, wherein the processor is further caused to:
in response to receiving a focus moving operation inputted by the user, in a case that a focus moves to the first area, display second preset prompt information, wherein the second preset prompt information is used to prompt information displayed by the similar information prompt tag.

16. The device according to claim 14, wherein the processor is further caused to:
prompt location information of a target similar text according to a preset prompt strategy in response to receiving a second operation from the user on the target similar text in the displayed similar modified texts.

17. The device according to claim 16, wherein the preset prompt strategy comprises one or more of:
indicating a location of the target similar text in the first text in a first preset format; and
switching an input focus of the target display page to a second area that displays a modification prompt tag corresponding to the target similar text.

18. The device according to claim 12, wherein the processor is further caused to:
determine a text to be modified from the similar modified texts; and
modify the text to be modified according to a preset modification strategy in response to receiving a modification confirmation operation inputted by the user.

19. The device according to claim 18, wherein the computer program causing the processor to determine the text to be modified from the similar modified texts comprises instructions to:
determine a similar modified text selected by the user as the text to be modified; or
determine a similar modified text that is selected by default as the text to be modified.

20. The device according to claim 19, wherein the similar text information further comprises a select control corresponding to each similar modified text, and the select control is configured to represent whether the similar modified text is selected; and the computer program causing the processor to determine the similar modified text selected by the user as the text to be modified comprises instructions to:
in response to receiving a selection operation from the user on the select control, determine a similar modified text corresponding to the selected select control as the text to be modified.

21. The medium according to claim 11, wherein the similar information prompt tag comprises one or more of a first preset prompt icon, a first preset prompt text, and a target number, wherein the target number is used to represent a number of the similar modified texts.
